(19) United States
(12) Patent Application Publication
(10) Pub. No.: US 2010/0096028 A1
(43) Pub. Date: Apr. 22, 2010

(54) ANTI-BACKFLOW VALVE

(75) Inventor: Wei-Dong QIU, Shenzhen (CN)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: GLOBE UNION INDUSTRIAL CORP.

(21) Appl. No.: 12/256,161

(22) Filed: Oct. 22, 2008

(51) Int. Cl. F16K 15/02

(52) U.S. Cl. 137/538

(57) ABSTRACT

An anti-backflow valve, including a valve seat and a plug slidingly disposed in the valve seat, is provided. The valve seat has a ring portion protruding inwards at a middle section of a flow passage thereof. The ring portion has a seat portion extended outwards on one side thereof. The plug has an accommodating chamber recessed inwards on one side thereof. The accommodating chamber has an opening radially penetrating through the plug at one end thereof distant from an inlet. The plug has a protruding portion at one end thereof adjacent to the inlet. An outer diameter of the protruding portion is larger than an inner diameter of the ring portion. A spring is provided between the protruding portion and the ring portion, and a portion of the plug penetrating through the ring portion has an O-ring engaged thereon corresponding to the seat portion.

### BACKGROUND OF THE INVENTION

1. Field of Invention

The present invention relates to a technical field of anti-backflow valves for water-supply facilities, and more particularly to an anti-backflow valve structure having a good operational sensitivity and a high degree of design freedom.

2. Related Art

Generally, in order to maintain pressure equilibrium between cold and hot water supply flow passages within a faucet and prevent a back flow, a check valve is additionally provided in the flow passages, for ensuring a smooth water outflow. In addition, in flow passages of a pull-out faucet, in order to prevent a back siphonage, a check valve is additionally provided in the flow passages as well.

FIG. 1 is a schematic view of a conventional check valve being assembled on a faucet pipe. Referring to FIG. 1, a cold water inlet 81 and a hot water inlet 82 of a faucet 8 are respectively provided with one check valve 9, so as to prevent a back flow.

FIG. 2 is a schematic structural view of the check valve. Referring to FIG. 2, the check valve 9 has a valve seat 91. The valve seat 91 has an accommodating chamber 92 therein. The accommodating chamber 92 has an inlet 921 at one end thereof, and a cover 93 at the other end. The cover 93 has a bushing 931 in a center thereof. A plurality of ribs 932 is extended around the bushing 931, so as to form a plurality of openings 933 on the cover 93. The accommodating chamber 92 has a plug 94 disposed therein. The plug 94 is provided with an O-ring 941 at one end thereof, and a rod 942 at the other end. The rod 942 is inserted into the bushing 931. A spring 95 is provided between the plug 94 and the cover 93, and the plug 94 is pushed to press against an end face 922 of the accommodating chamber 92 adjacent to the inlet 921 by the elastic force of the spring 95, thereby achieving a normally enclosed state.

FIG. 3 is a schematic view of operations of the above check valve 9. Referring to FIG. 3, when the faucet is open, a water flow flows in via the inlet 921. At this point, the water pressure pushes the plug 94 to compress the spring 95, so as to cause the O-ring 941 of the plug 94 to depart from the end face 922 of the accommodating chamber 92. In this manner, the water flow can enter the accommodating chamber 92 via the inlet 921, then flow through a gap between the plug 94 and an inner wall of the accommodating chamber 92, and finally flow into the faucet via the opening 933 of the cover 93.

When the faucet is closed, the water pressures at two ends of the check valve 9 are equal. The plug 94 is pressed against the end face 922 of the accommodating chamber 92 under the action of the spring 95, thus achieving the enclosed state. Alternatively, when the pipe pressure within the faucet is larger than the water-inlet pressure (for example, when cold water and hot water mixed-flows), the check valve 9 also achieves the enclosed state under the action of the spring 95, thereby preventing a back flow.

However, the above check valve structure has the following problems.

1. Since the water flow has to flow through the accommodating chamber via the gap between the plug and the inner wall of the accommodating chamber, the plug has to be designed to be of a certain size smaller than the inner wall of the accommodating chamber. Moreover, since the O-ring is engaged on the plug and used to press against the end face of the accommodating chamber so as to achieve the enclosed state, the end face has to be of a certain size smaller than the plug, which causes the inlet to have a fairly small size. In this manner, the active area of the water flow on the plug through the inlet correspondingly becomes small, which will cause the motion of the plug to become insensitive and thus cause a problem of water flux control.

2. The check valve is pressed against the end face of the accommodating chamber by the O-ring of the plug so as to block the water flow. In order to achieve the effect of blocking the water flow, a spring having a large elastic coefficient is commonly used to increase the force of the O-ring against the end face. After the acting force of the spring is increased, a pressure required for the water flow to push off the plug is correspondingly increased, which will cause the motion of opening the check valve to become insensitive.

3. As described above, the sizes of the accommodating chamber and the plug and the inlet are associated with one another. If it is desired to change a maximum water flux of the check valve, the sizes of the accommodating chamber and the plug and the inlet may need to be simultaneously changed, which results in a low degree of design freedom of the check valve. In other words, for check valves designed for different fluxes, plugs and valve seats thereof (having an accommodating chamber and an inlet therein) cannot be alternatively used, which increases the manufacturing and inventory costs as well.

Therefore, there is surely a need for further improving the above check valve structure.

### SUMMARY OF THE INVENTION

The present invention is directed to an anti-backflow valve having a good operational sensitivity and a high degree of design freedom, which can solve the above problems.

The present invention is also directed to an anti-backflow valve, which can effectively reduce the manufacturing and inventory costs.

In order to achieve the above objectives, the present invention provides an anti-backflow valve, which includes a valve seat and a plug slidingly disposed in the valve seat. The valve seat has a ring portion protruding inwards at a middle section of a flow passage penetrating therethrough. The ring portion has a seat portion extended outwards on one side thereof. The plug is sleeved into the ring portion in a slidable manner. The plug has an accommodating chamber recessed inwards. The accommodating chamber has an opening radially penetrating through the plug at one end thereof distant from an inlet. The plug has a protruding portion at one end thereof adjacent to the inlet. An outer diameter of the protruding portion is larger than an inner diameter of the ring portion. The plug has an O-ring engaged thereon at one end thereof adjacent to the protruding portion. An elastic element is provided between the protruding portion and the ring portion such that the O-ring is forced to press against the seat portion by an elastic force thereof.

Therefore, in the present invention, the inner wall of the accommodating chamber and the protruding portion can jointly form an active area for the water flow to push the plug, so as to enlarge the active area of the water flow, thereby improving the sensitivity of sliding of the plug and achieving a more smooth control over the water flux.

On the other hand, the seat portion is a recessed cone-shaped structure. The conical surface configuration can improve the sealing effect between the O-ring and the seat portion. Therefore, a good water-flow blocking effect can be achieved without using a spring having a large elastic coefficient, which reduces the force required for the water flow to push off the plug, thereby improving the sensitivity of sliding of the plug.

Moreover, in the structure of the present invention, a maximum water flux of the anti-backflow valve can be changed simply by changing the number and size of the opening, and the remaining portions and sizes of the structure need not to be changed. In this manner, the manufacturing and inventory costs are effectively reduced and the degree of design freedom of the product is improved.

In order to make the foregoing and other objectives, features, and advantages of the present invention comprehensible, an embodiment is described in detail below with reference to the accompanying drawings.

Definitely, the present invention allows some variations on certain parts or arrangement of the parts, but the embodiment selected in the present invention is illustrated in detail in the specification, and the construction thereof is shown in the accompanying drawings.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a conventional check valve being assembled on a faucet pipe;

FIG. 2 is a schematic structural view of the check valve;

FIG. 3 is a schematic view of operations of the check valve;

FIG. 4 is a three-dimensional exploded view of the present invention;

FIG. 5 is a combined cross-sectional view of the present invention; and

FIG. 6 is a schematic view of a using state of the present invention.

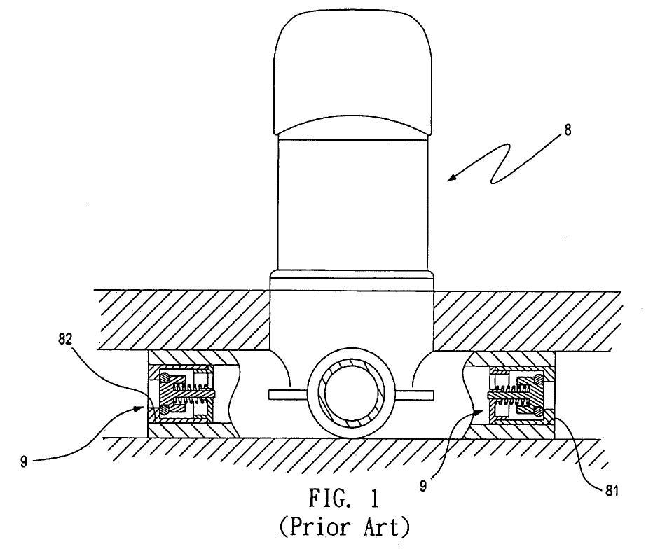

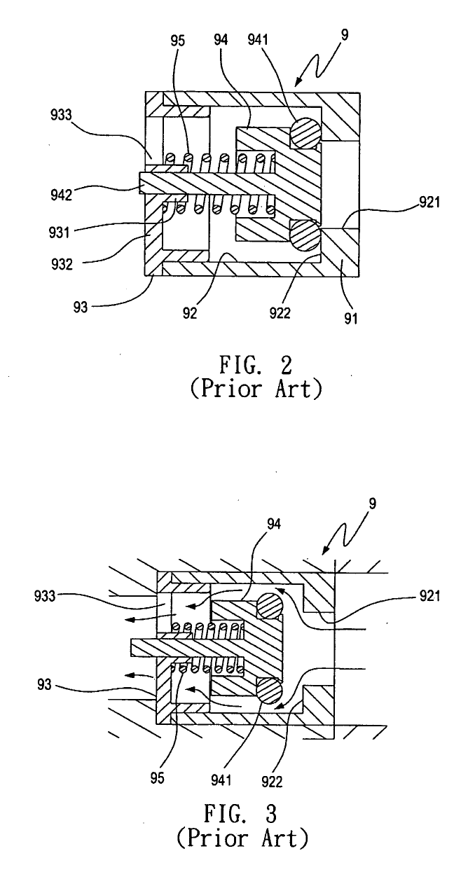

### DETAILED DESCRIPTION OF THE INVENTION

As for the technical means adopted in the present invention to achieve the above objective, a detailed illustration is given below through the embodiment and accompanying drawings.

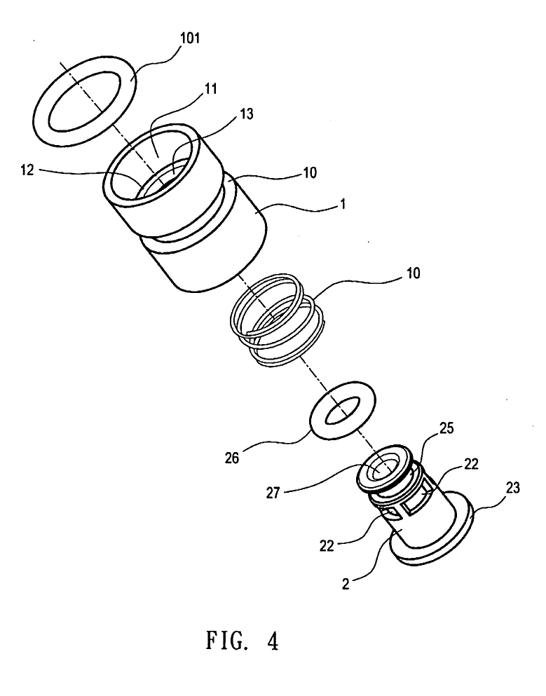

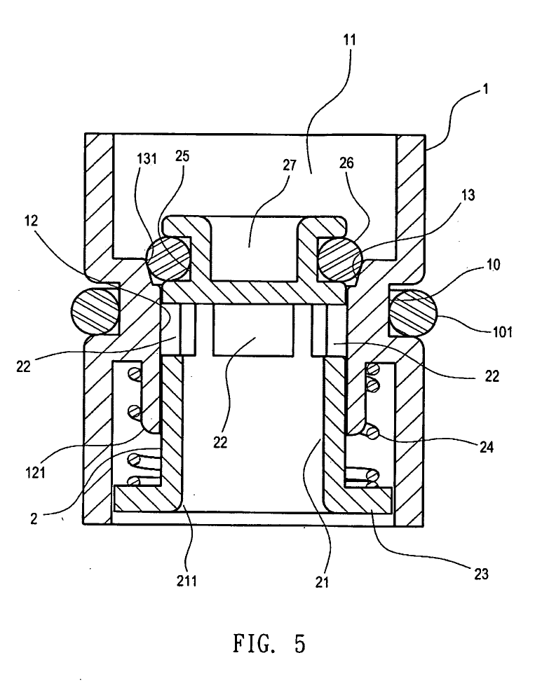

FIG. 4 is a three-dimensional exploded view of the present invention, and FIG. 5 is a combined cross-sectional view of the present invention. An anti-backflow valve of the present invention is suitable for being assembled into a pipe of a water-supply facility, for example, into a pipe within a faucet or a pipe within a shower assembly.

An anti-backflow valve of the present invention includes a valve seat 1 and a plug 2 slidingly disposed in the valve seat 1. An outer edge of the valve seat 1 has an annular groove 10 recessed therein, and the annular groove 10 has a sealing ring 101 disposed therein. The valve seat 1 has a flow passage 11 penetrating therethrough. A middle section of the flow passage 11 has a ring portion 12 protruding inwards. The ring portion 12 has a seat portion 13 extended outwards on one side thereof. The seat portion 13 is a recessed cone-shaped structure and has a large-diameter portion 131 on one side thereof distant from the ring portion 12. The ring portion is provided with an annular flange 121 extended on one side thereof relative to the seat portion 13.

The plug 2 is sleeved into the ring portion 12 and the annular flange 121 in a slidable manner. The plug 2 has an accommodating chamber 21 recessed inwards. The accommodating chamber 21 is formed with an inlet 211 at one end of the plug 2, and has four openings 22 disposed radially opposite to one another and radially penetrating through the plug 2 at one end thereof distant from the inlet 211. The plug 2 has a protruding portion 23 at one end thereof adjacent to the inlet 211. An outer diameter of the protruding portion 23 is larger than an inner diameter of the ring portion 12. An elastic element is provided between the protruding portion 23 and the ring portion 12, which is a spring 24 in this embodiment. The spring 24 is sleeved at the annular flange 121. A portion of the plug 2 penetrating through the ring portion 12 has an annular groove 25 for an O-ring 26 to be engaged. An outer diameter of the O-ring 26 is larger than the inner diameter of the ring portion 12 and smaller than the large-diameter portion 131 of the seat portion 13. Therefore, the O-ring 26 is forced to press against the seat portion 13 by an elastic force of the spring 24 so as to achieve an effect of blocking the flow passage 11. In addition, the plug 2 has a recessed portion 27 in a center of one end thereof adjacent to the O-ring 26.

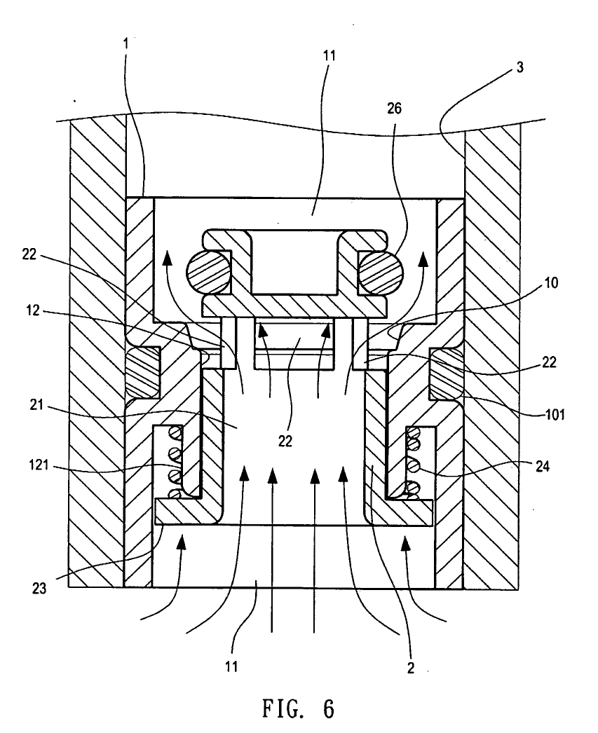

FIG. 6 is a schematic view of a using state of the present invention. Referring to FIG. 6, the anti-backflow valve of the present invention is disposed in a pipe 3 of a water-supply facility by the valve seat 1. When disposing, the end of the plug 2 having the protruding portion 23 is disposed adjacent to an upstream side of the water-supply pipe, and a sealing effect is achieved between the valve seat 1 and the pipe 3 by the sealing ring 101 engaged at the outer edge of the valve seat 1.

When the water-supply facility is open, the water flow flows in via the flow passage 11 of the valve seat 1. At this point, the water pressure simultaneously pushes an inner wall of the accommodating chamber 21 and the protruding portion 23 of the plug 2 to compress the spring 24, so as to enable the plug 2 to slide along the ring portion 12 and the annular flange 121 thereof, thereby causing the O-ring 26 to depart from the seat portion 13. In this manner, the water flow can flow through the seat portion 13 via the opening 22, enter the other side of the flow passage 11, and then flow into the water-supply facility. When the water-supply facility is closed, water pressures of the flow passage 11 at two sides of the plug 2 are equal. The plug 2 moves back under the elastic force of the spring 24, which forces the O-ring 26 to press against the seat portion 13 so as to achieve the enclosed state. Alternatively, when the pipe pressure within the water-supply facility is larger than the water-inlet pressure (for example, when cold water and hot water mixed-flows), the anti-backflow valve achieves the enclosed state as well, thereby preventing a back flow.

The structure of the present invention has the following features.

1. Since the water flow passes through the plug 2 via the opening 22 and then enter the other side of the flow passage 11 via the seat portion 13, and the plug 2 has the protruding portion 23 at one end of the inlet 211 of the accommodating chamber 21, both the inner wall of the accommodating chamber 21 and the protruding portion 23 can become the active area for the water flow to push the plug 2. Therefore, the active area of the water flow can be greatly increased, thereby improving the sensitivity of sliding of the plug 2 and achieving a more smooth control over the water flux.

2. Since the O-ring 26 of the plug 2 of the present invention is pressed against the seat portion 13 so as to block the water flow and the conical surface form formed by the seat portion 13 having the recessed cone-shaped structure has a pushing effect on the O-ring 26, a better sealing effect between the O-ring 26 and the seat portion 13 is achieved. Therefore, a good water-flow blocking effect can be achieved in the present invention without using a spring having a large elastic coefficient. That is to say, the force required for the water flow to push off the plug is reduced, and the sensitivity of sliding of the plug 2 is thus improved.

3. Different countries or regions have different specifications on water utilization, for example, on the maximum flux of the water-supply facility. However, for the structure of the present invention, the maximum water flux of the anti-backflow valve can be changed simply by changing the number and size of the opening 22, and the remaining portions and sizes of the structure need not to be changed. In this manner, the manufacturing and inventory costs is effectively reduced and the degree of design freedom of the product is improved.

Therefore, the anti-backflow valve of the present invention can surely achieve the objectives of improving the operational sensitivity and degree of design freedom.

The disclosure of the embodiment is intended to illustrate the present invention, but not to limit the present invention, so the variation of cited values or replacement of equivalent elements still falls within the scope of the present invention.

Through the above detailed descriptions, it is apparent to those skilled in the art that the present invention can surely achieve the above objectives, which conforms to the provisions of the patent law, so as to apply for a patent application.

What is claimed is:

1. An anti-backflow valve, comprising:
a valve seat, having a flow passage penetrating therethrough and a ring portion protruding inwards at a middle section of the flow passage, the ring portion having a seat portion extended outwards on one side thereof; and
a plug, sleeved into the ring portion in a slidable manner, the plug having an accommodating chamber recessed inwards, the accommodating chamber being formed with an inlet at one end of the plug and has an opening radially penetrating through the plug at one end thereof distant from the inlet, the plug having a protruding portion at one end thereof adjacent to the inlet, an outer diameter of the protruding portion being larger than an inner diameter of the ring portion, the plug having an O-ring engaged thereon at one end thereof adjacent to the protruding portion, and an elastic element being provided between the protruding portion and the ring portion such that the O-ring being forced to press against the seat portion by an elastic force of the elastic element.

2. The anti-backflow valve according to claim 1, wherein the ring portion is provided with an annular flange extended towards the protruding portion of the plug.

3. The anti-backflow valve according to claim 2, wherein the elastic element is sleeved at an outer edge of the flange.

4. The anti-backflow valve according to claim 1, wherein an outer edge of the valve seat has at least one annular groove recessed therein, and the annular groove has a sealing ring disposed therein.

5. The anti-backflow valve according to claim 1, wherein the plug has a recessed portion in a center of one end thereof adjacent to the O-ring.

6. The anti-backflow valve according to claim 1, wherein the opening of the plug is provided in form of four radially opposite openings.

7. The anti-backflow valve according to claim 1, wherein the seat portion is a recessed cone-shaped structure and has a large-diameter portion on one side thereof distant from the ring portion.

8. The anti-backflow valve according to claim 7, wherein an outer diameter of the O-ring is larger than the inner diameter of the ring portion and smaller than the large-diameter portion of the seat portion.

9. The anti-backflow valve according to claim 1, wherein the elastic element is a spring.
